(19) United States
(12) Patent Application Publication
(10) Pub. No.: US 2026/0269665 A1
(43) Pub. Date: Sep. 10, 2026

(54) Stator having a protective device

(71) Applicant: Hilti Aktiengesellschaft, Schaan (LI)

(72) Inventors: Michael UNSÖLD, Penzing (DE); Thomas LANDES, Unterdiessen (DE); Florian HURKA, Margertshausen (DE); Thomas SCHAEFER, Obermeitingen (DE); Manfred JAKOB, Kaufering (DE)

(21) Appl. No.: 19/473,864

(22) PCT Filed: Mar. 26, 2024
(86) PCT No.: PCT/EP2024/058055

§ 371 Date: Oct. 9, 2025

(30) Foreign Application Priority Data
Apr. 12, 2023 (EP) 23167514.1

(51) Int. Cl. H02K 1/18; H02K 7/14

(52) U.S. Cl. CPC H02K 1/185; H02K 7/145

(57) ABSTRACT

A stator, in particular for an electric motor, comprising a laminated core and coil windings having individual wire ends, the stator having a protective device which is connectable, in a radial arrangement around the wire ends, to a first end of the stator. An electric motor having a stator and a power tool having a stator are also provided.

The present invention relates to a stator, in particular for an electric motor, comprising a stator laminated core and coils having individual wire ends.

The invention furthermore relates to an electric motor having a stator.

The invention furthermore relates to a power tool having a stator.

### BACKGROUND

An electric motor normally and substantially consists of a static stator and of a rotor that is movable relative to the stator.

The stator has a number of pole teeth, around each of which a winding wire is wound in order to produce a winding coil. By means of the winding coils, a magnetic field can be generated, by means of which the rotor can be set in rotation. The free ends of the winding wire of each winding coil serve are connected to an interconnection ring (also referred to as connection ring). The free ends of the winding wire furthermore project beyond an end of the stator.

Use in power tools often places a high mechanical load on the electric motor. Since power tools are commonly dropped or subjected to impacts or other forms of misuse, various forms of damage can occur to the electric motor or to individual components of the electric motor.

It is often a problem here that the free ends of the winding wire react particularly sensitively to, and can be damaged by, the mechanical loads.

### SUMMARY OF THE INVENTION

It is an object of the present invention to solve the problem described above.

The present invention provides a stator, in particular for an electric motor, comprising a stator laminated core and coils having individual wire ends.

According to the invention, a protective device is provided which is connectable, in a radial arrangement around the wire ends, to a first end of the stator.

Effective protection for the wire ends can thus be established in a simple manner.

It is possible here for the protective device to be ring-shaped. In this way, the protective device can be suitably positioned on the stator.

According to one advantageous exemplary embodiment, it can be possible for the protective device to be of multi-part design. Possible manufacturing tolerances of the stator can thus be easily compensated. The individual parts of the protective device therefore do not need to be arranged in a perfect circle on the stator.

According to a further advantageous exemplary embodiment, it can be possible for the protective device to comprise at least one pocket-like recess for receiving the wire ends.

According to one advantageous exemplary embodiment, it can be possible for the protective device to comprise a connecting device for releasably connecting the protective device to the first end of the stator.

According to a further advantageous exemplary embodiment, it can be possible for the protective device to comprise at least one axial opening for receiving and holding a bearing block.

According to one advantageous exemplary embodiment, it can be possible for the recess to be of multi-part design. In this way, manufacturing tolerances can be compensated and the amount of insulating compound or adhesive that can be introduced into the recesses can be individually adapted.

The present invention also provides an electric motor having a stator.

The present invention also provides a power tool having a stator.

Further advantages can be found in the following description of the figures. A particularly preferred exemplary embodiment of the present invention is illustrated in the figures. The figures, the description and the claims include numerous features in combination. A person skilled in the art will expediently also consider the features individually and combine them to form sensible further combinations.

### BRIEF DESCRIPTION OF THE DRAWINGS

Identical and similar components are denoted by the same reference signs in the figures,

in which:

FIG. 1 shows a side view of a power tool having an electric motor;

FIG. 2 shows a perspective view of an electric motor having a stator and having a protective device according to a first embodiment in an assembled state;

FIG. 3 shows a perspective view of the electric motor having the stator and having the protective device according to the first embodiment in a disassembled state;

FIG. 4 shows a perspective view of the protective device according to the first embodiment;

FIG. 4a shows a perspective view of the protective device in a multi-part embodiment;

FIG. 5 shows a sectional view through a first end of the electric motor and the protective device according to the first embodiment;

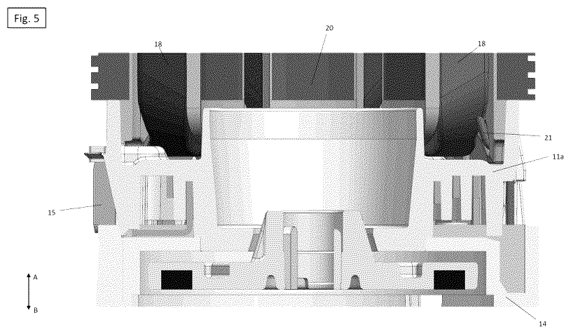

FIG. 6 shows a perspective view of the electric motor having the stator and having a protective device according to a second embodiment in an assembled state;

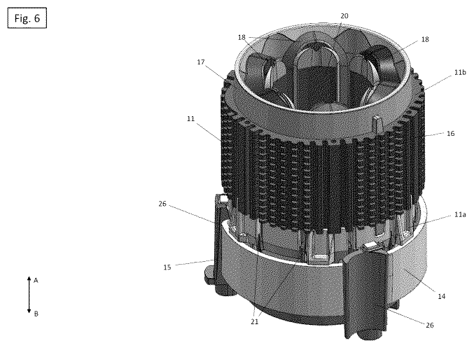

FIG. 7 shows a perspective view of the electric motor having the stator and having the protective device according to the second embodiment in a disassembled state;

FIG. 8 shows a perspective view of the protective device according to the second embodiment;

FIG. 9 shows a sectional view through a first end of the electric motor and the protective device according to the second embodiment;

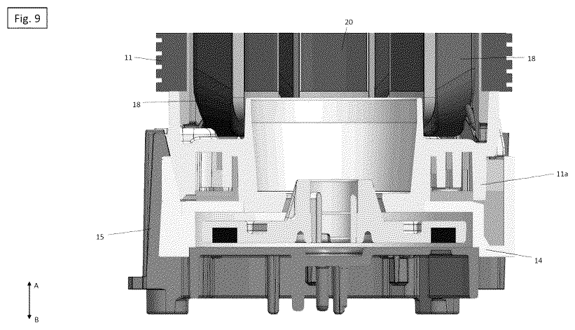

FIG. 10 shows a perspective view of the electric motor having the stator and having a protective device according to a third embodiment in an assembled state;

FIG. 11 shows a perspective view of the electric motor having the stator and having the protective device according to the third embodiment in a disassembled state;

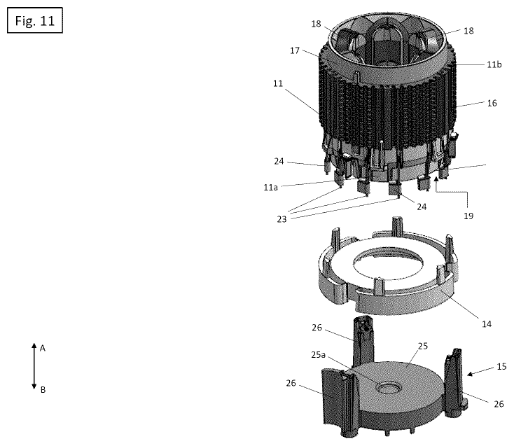

FIG. 12 shows a perspective view of the protective device according to the third embodiment; and

FIG. 13 shows a sectional view through a first end of the electric motor and the protective device according to the third embodiment.

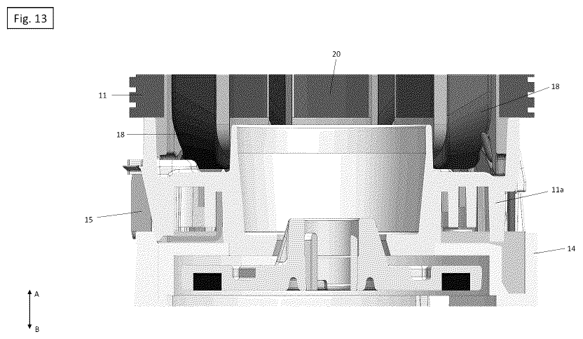

### DETAILED DESCRIPTION

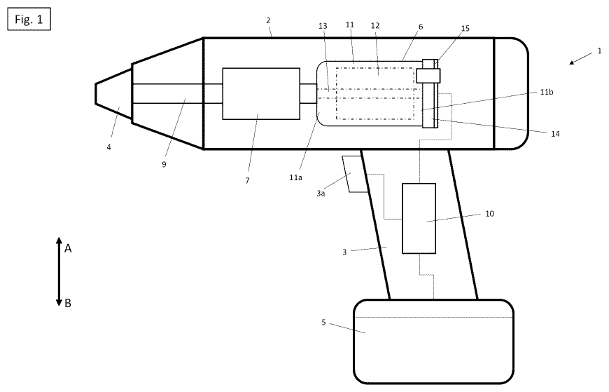

FIG. 1 shows a power tool 1 in the form of a rechargeable battery-operated screwdriver.

The power tool 1 may alternatively also be designed in the form of a hammer drill, a grinder, a saw or the like.

As indicated in FIG. 1, the power tool 1 substantially comprises a housing 2, a handle 3, a tool fitting 4 and a power supply 5. Furthermore, an electric motor 6, a transmission device 7, an output shaft 9 and a control unit 10 are contained in the interior of the housing 2 of the power tool 1.

Arranged at a front end of the handle 3 is an actuating switch 3a by means of which the power tool 1 can be activated.

The electric motor 6 serves to generate a torque and is connected to the transmission device 7 such that a torque generated by the electric motor 6 can be transmitted to the transmission device 7. From the transmission device 7, the torque is transmitted via the output shaft 9 to the tool fitting 4. The tool fitting 4 serves to receive and hold a tool. In the case of a rechargeable battery-operated screwdriver, the tool may be a screwdriver bit or drill bit.

In the present exemplary embodiment, the power supply 5 is in the form of a rechargeable battery. The power supply 5 may alternatively also be in the form of an electrical cable for connecting the power tool 1 to a mains power source.

The control unit 10 is used to control and regulate the different functions of the power tool 1.

The electric motor substantially includes a stator 11, a rotor 12, a rotor shaft 13, a protective device 14 and a bearing block 15.

The stator 11 substantially includes a stator laminated core 16, a winding support 17, six coils 18 and a connection ring 19.

The stator 11 is cylindrical and comprises a first end 11a and a second end 11b. The connection ring 19 and the protective device 14 are positioned at the first end 11a of the stator 11. The winding support 17 is situated opposite, at the second end 11b of the stator 11.

The stator laminated core 16 consists of individual laminations that are connected to form a cylindrical stator core. Six radially arranged pole teeth 20 project into the interior of the laminated core. A winding wire 21 is wound around each pole tooth 20 in order to produce the coil 18.

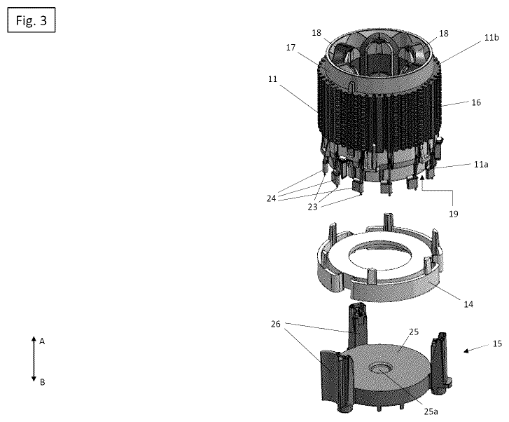

As shown in FIG. 3, the ends 23 of each winding wire 21 project in a direction B beyond the first end 11a of the stator 11 and are connected to the connection ring 19.

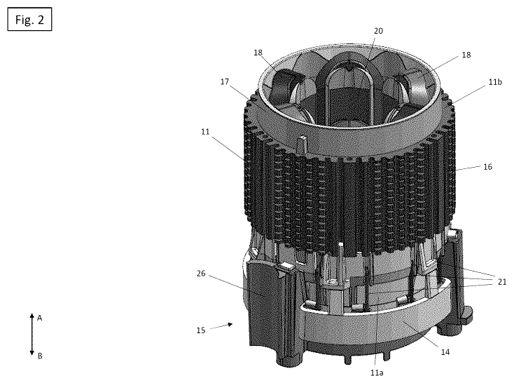

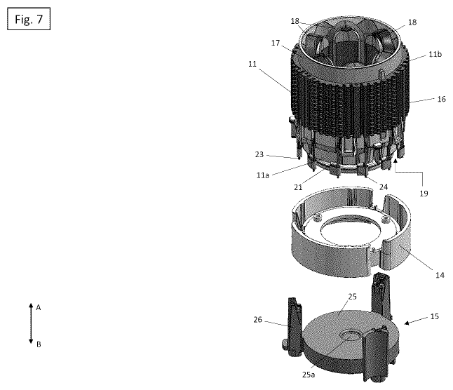

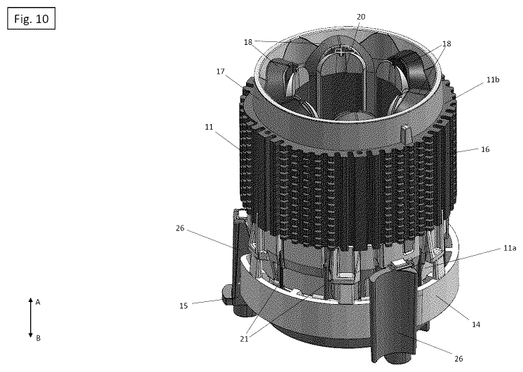

As indicated in FIGS. 2, 7 and 10, each end 23 of a winding wire 21 is electrically connected to the connection ring 19 by means of a clamping element 24.

The rotor 12 substantially includes a rotor laminated core, and is positioned rotatably in the interior of the stator 11. The rotor laminated core likewise consists of individual laminations that are joined together to form a cylindrical core.

The rotor shaft 13 is designed substantially as an elongate cylinder and is positioned rotationally conjointly in the rotor 12. As mentioned above, the rotor shaft 13 serves for transmitting a torque from the electric motor 6 to the transmission device 7.

The bearing block 15 serves for supporting the electric motor 6 within the housing 2 of the power tool 1.

As shown in the figures, the bearing block 15 is designed substantially as a circular disk 25 with three uniformly spaced assembly elements 26. Indicated in the center of the circular disk 25 is a depression 25a that serves for receiving and supporting an end of the rotor shaft 13. The assembly elements 26 project from the disk 25 in a direction A. By means of the assembly elements 26, the bearing block 15 is releasably connected to the first end 11a of the stator 11.

FIGS. 2 and 3 show the stator 11 of the electric motor 6 with a protective device 14 according to a first embodiment. FIG. 2 shows the electric motor 6 with the protective device 14 according to the first embodiment in an assembled state.

FIG. 3 shows the electric motor 6 with the protective device 14 according to the first embodiment in a disassembled state.

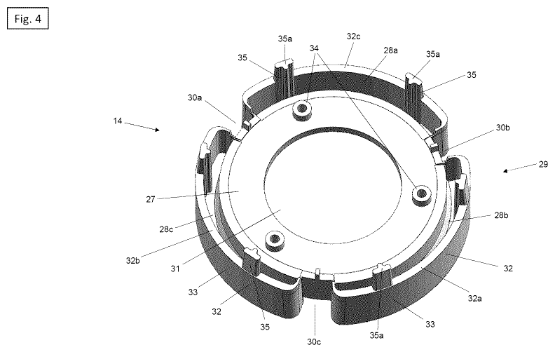

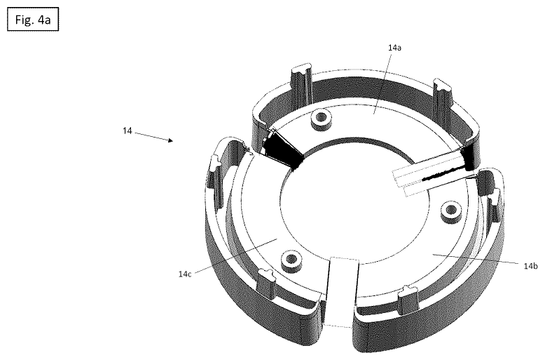

As shown in particular in FIG. 4, the protective device 14 according to the first embodiment substantially includes a ring-shaped carrier element 27, a first, a second and a third recess 28a, 28b, 28c, a connecting device 29, and a first, a second and a third axial opening 30a, 30b, 30c. The protective device 14 is designed such that it can be releasably connected to the first end 11a of the stator 11.

The ring-shaped carrier element 27 comprises a circular central opening 31, which in the assembled state is positioned around the first end 11a of the stator 11.

The first, the second and the third recess 28a, 28b, 28c are substantially arcuate and are arranged in a ring shape on an outer lateral surface 32 of the carrier element 27. Each of the recesses 28a, 28b, 28c is of pocket-like design with an outer side wall 33. Here, the height HS of the side wall 33 projects beyond the carrier element 27 in the direction A. The pocket-like recesses 28a, 28b, 28c serve to receive and hold the clamping elements 24, connected to a winding wire end 23, and a liquid insulating compound.

It is also possible for a liquid adhesive to be introduced into the recess instead of the insulating compound.

Neither the insulating compound nor the adhesive is illustrated in the figures.

Each recess 28a, 28b, 28c is designed such that four clamping elements 24 together with the winding wire ends 23 can be received, and additionally at least such an amount of insulating compound can be introduced into the recess 28a, 28b, 28c that each clamping element 24 together with the winding wire end 23 can be encapsulated with and thus insulated by the insulating compound.

The connecting device 29 according to the first embodiment is implemented in the present exemplary embodiment by three sleeves 34 each having a central opening and by six connecting projections 35. As shown in FIG. 4, the connecting projections 35 are arranged, at approximately uniform intervals with respect to one another, on the outer side wall 33.

It is alternatively also possible for more or fewer than three sleeves 34 and/or more or fewer than six connecting projections 35 to be provided. Screws are driven through the sleeves 34 in order to fasten the protective device to the first end 11a of the stator 11.

By means of the connecting projections, the protective device 14 is clamped together with the first end 11a of the stator 11.

Each axial opening 30a, 30b, 30c serves for receiving and holding the bearing block 15. The three assembly elements 26 of the bearing block 15 are in this case positioned in the correspondingly designed openings 30a, 30b, 30c.

FIG. 4a shows a protective device 14 according to a further embodiment. Said protective device 14 is formed in three uniform, arcuate parts 14a, 14b, 14c, which are positioned on the first end 11a of the stator 11.

According to a further embodiment, the protective device 14 may also be formed in more or fewer than three uniform, arcuate parts 14a, 14b, 14c.

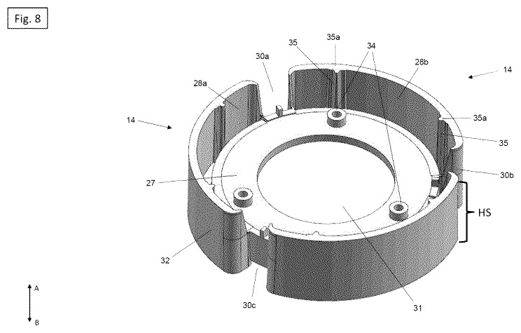

FIG. 8 shows a protective device 14 according to a second embodiment. The protective device 14 according to the second embodiment differs from the protective device 14 according to the first embodiment in that the outer lateral surfaces 32 of the pocket-like recesses 28a, 28b, 28c are taller.

In other words, the height HS of the outer lateral surfaces 32 of the protective device 14 according to the second embodiment is greater than the height HS of the outer lateral surfaces 32 of the protective device 14 according to the first embodiment.

The taller lateral surfaces 32 serve to enlarge the volume of the pocket-like recesses 28a, 28b, 28c, whereby a greater volume of insulating compound can be introduced into each recess 28a, 28b, 28c and a more pronounced insulating action can be established for the winding wire end 23.

Furthermore, in the protective device 14 according to the second embodiment, the connecting projections 35 are an integral part of the outer lateral surface 32 of the pocket-like recesses 28a, 28b, 28c. As shown in FIG. 4, in the protective device 14 according to the first embodiment, the connecting projections 35 project in the direction A beyond the upper edge 32a of the outer lateral surfaces 32 of the recesses 28a, 28b, 28c. By contrast, in the protective device 14 according to the second embodiment, the upper ends 35a of the connecting projections 35 end at the level of the upper edge 32a of the outer lateral surfaces 32 of the recesses 28a, 28b, 28c.

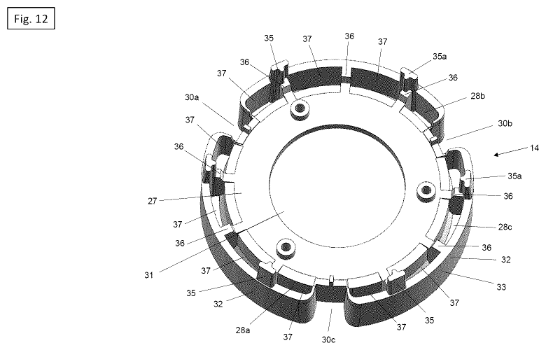

FIG. 12 shows a protective device 14 according to a third embodiment. The protective device 14 according to the third embodiment differs from the protective device 14 according to the first embodiment in that each pocket-like recess 28a, 28b, 28c has three uniformly spaced separating elements 36 for creating four chambers 37. Here, the four chambers 37 have substantially equal volumes.

Furthermore, the volume of each chamber 37 is at least approximately equal to the volume of a clamping element 24 together with an end 23 of a winding wire 21. In this way, the clamping element 24 together with the winding wire end 23 can be received in a chamber 37.

In one preferred embodiment, the volume of a chamber 37 is somewhat larger than the volume of a clamping element 24 together with a winding wire end 23, such that an adequate amount of insulating compound can be introduced into the chamber 37 in addition to the clamping element 24 together with the winding wire end 23. It is necessary here for at least such an amount of insulating compound to be introduced into the chamber 37 that the clamping element together with the winding wire end 23 is fully encapsulated with the insulating compound.

In an alternative embodiment, it is furthermore possible for more or fewer than three separating elements 36 to be provided in each pocket-like recess 28a, 28b, 28c, such that more or fewer than four chambers 37 are correspondingly created.

### LIST OF REFERENCE SIGNS

1 Power tool
2 Housing
3 Handle
3a Actuating switch
4 Tool fitting
5 Power supply
6 Electric motor
7 Transmission device
9 Output shaft
10 Control unit
11 Stator
11a First end of the stator
11b Second end of the stator
12 Rotor
13 Rotor shaft
14 Protective device
14a Arcuate part of the protective device
14b Arcuate part of the protective device
14c Arcuate part of the protective device
15 Bearing block
16 Laminated stator core
17 Winding support
18 Coil
19 Connection ring
20 Pole tooth
21 Winding wire
23 End of a winding wire
24 Clamping element
25 Circular disk of the bearing block
25a Depression
26 Assembly element
27 Carrier element
28a First recess
28b Second recess
28c Third recess
29 Connecting device
30a First axial opening
30b Second axial opening
30c Third axial opening
31 Circular central opening
32 Outer lateral surface
32a Upper edge of the outer lateral surface of the recesses
33 Side wall
34 Sleeve
35 Connecting projection
35a Upper end of the connecting projection
36 Separating element
37 Chamber
HS Height of the side wall

What is claimed is:

1-8. (canceled)

9. A stator comprising:
a stator laminated core and coils having individual wire ends;
a protector connectable, in a radial arrangement around the wire ends, to a first end of the stator.

10. The stator as recited in claim 9 wherein the protector is of multi-part design.

11. The stator as recited in claim 9 wherein the protector includes at least one pocket-like recess for receiving the wire ends.

12. The stator as recited in claim 9 wherein the protector includes a connector for releasably connecting the protector to the first end.

13. The stator as recited in claim 9 wherein the protector includes at least one axial opening for receiving and holding a bearing block.

14. The stator as recited in claim 11 wherein the at least recess is includes multiple recesses.

15. An electric motor comprising the stator as recited in claim 9.

16. A power tool comprising the stator as recited in claim 9.
